(19) United States
(12) Patent Application Publication
(10) Pub. No.: US 2026/0051745 A1
(43) Pub. Date: Feb. 19, 2026

(54) ELECTRICAL FILTER CIRCUIT FOR AN ELECTRIC DRIVE

(71) Applicant: Robert Bosch GmbH, Stuttgart (DE)

(72) Inventors: Alois Taranetz, Ardagger (AT); Dennis Burger, Friolzheim (DE)

(21) Appl. No.: 18/996,134

(22) PCT Filed: May 24, 2023
(86) PCT No.: PCT/EP2023/063928

§ 371 Date: Jan. 17, 2025

(30) Foreign Application Priority Data
Jul. 27, 2022 (DE) 10 2022 207 683.4

(51) Int. Cl. H02J 7/14; H02M 1/12

(52) U.S. Cl. CPC H02J 7/1484; H02M 1/123; H02M 1/126; H02J 2207/20

(57) ABSTRACT

The present invention creates an electrical filter circuit (100) for an electric drive (200), wherein the filter circuit (100) comprises an x-capacitor (CX_i), a first and a second y-capacitor (CY1_i, CY2_i). The x-capacitor (CX_i) is connected between a first and the third filter output terminal (212, 216), or a first and a third filter input terminal (213, 217), and the first y-capacitor (CY1_i) is connected between the third filter output terminal (216) or the third filter input terminal (217) and a reference potential or ground. The second y-capacitor (CY2_i) is connected between the second filter output terminal (214) or the second filter input terminal (215) and a reference potential or ground.

### BACKGROUND

The present invention relates to an electrical filter circuit for an electric drive, in particular to operate a vehicle, a drive train comprising the electric circuit, and a vehicle comprising a drive train, as well as a method of operating the electric circuit, a computer program, and a computer readable storage medium.

E-mobility is an important part of our efforts to develop more environmentally-friendly methods of travel. However, in order to achieve widespread acceptance of electric vehicles, several prerequisites must be met. In addition to a sufficient vehicle range, power sources must be ubiquitously available to ensure that electric vehicles can be charged at all times. Further, the required charging time must be kept low in order to avoid long delays.

When the electric vehicle is charged at an alternating voltage (AC) charging station, such as when connected to the public power grid, the alternating voltage is converted by a rectifier, preferably an internal rectifier within the vehicle, to a DC voltage (DC). Fast charging stations that provide direct DC voltage and are characterized by a lower charging time are increasingly common. An exemplary DC fast charging station is known from WO 2012/038222 A3. An inverter for converting electrical energy of a DC voltage source into alternating voltage to drive an electric machine is known from WO 2019/215128 A1. This inverter is further configured to raise a charging voltage of a charging device to a higher voltage. Such boosters are used if the available charging voltage is less than the voltage required to charge a vehicle battery. The charging voltage, for example at a voltage level of 400 volts, is provided via at least one winding of the connected electric machine. In both motor, generator, and booster modes, the power switches of the inverter are cycled to provide the desired voltage at the output or input of the inverter for boosting a charging voltage, for example 400 volts, to a battery voltage of a battery or a high-volt battery, for example 800 volts, in charging mode. Common mode and differential mode electrical disturbance variables are thereby formed. These are typically filtered through an HV (high volt) filter to reduce EMC interference emission. The HV filter also minimizes the EMC interference emissions in charging operation towards a supply network, i.e. towards the high-voltage battery or towards a public charging network, preferably a DC voltage charging network, or a charging station. In charging mode, once a charge plug is connected to a public charging station, the permissible electromagnetic interference emissions limits that must be complied with on the charging connection lines are particularly low. An obvious solution for an electrical filter circuit to be used, or an HV filter, would be a symmetrical filter circuit in which all 3 charging connection lines are filtered to the same degree, i.e. symmetrically, by means of y-capacitors in relation to mass or a reference potential, preferably the chassis of the vehicle. An important constraint in sizing the y-capacitors is that the sum of the capacity of all y-capacitors in the vehicle is limited due to safety reasons. A limit of 600 nF, for example, would mean that 6 capacitors with 100 nF each could be used in a symmetrical filter, for example, 2 capacitors per line with a total together of 200 nF per line. There is therefore a need for solutions with a particularly good reduction of electromagnetic interference emissions with a minimum sum of the capacities of the y-capacitors, preferably in an electric drive train for a vehicle.

### SUMMARY

Based on the finding that significantly lower limits for permissible electromagnetic interference emissions must be complied with in the booster mode to boost a charging voltage to a battery voltage of a battery in the charging operation than in drive mode, e.g., in the motorized or generator operation of the electric drive chain, the lines relevant for booster mode are in particular taken into account in the solution. The present invention creates an electrical filter circuit, a drive train, a vehicle according to the disclosure.

Accordingly, the invention relates to an electrical filter circuit for an electric drive. The filter circuit comprises a three-pole filter input connection on the input side. Preferably, the filter input connection is a DC voltage connector to be connected to the DC voltage sources or DC voltage sinks, preferably batteries and/or an external charging voltage. The filter circuit comprises a three-pole filter output connection on the output side. Preferably, the filter output connection is a DC voltage terminal to which DC voltage sources or DC voltage sinks are connected, preferably a DC voltage input of an inverter or a winding connection point of a winding of an electric machine. Thus, the input-side three-pole filter input connection is configured to be connected to a positive pole of a high voltage battery at a first filter input connection, to be connected to a negative pole of a high voltage battery at a second filter input connection, and to be connected to a positive pole of a charging voltage at a third filter input connection. Preferably, the charging voltage is significantly lower than the battery voltage so that the charging voltage is initially boosted to charge the high-voltage battery. Preferably, the power switching elements of the inverter and the windings of the electric machine are utilized to boost the charging voltage. The output-side three-pole filter output connection is configured to be connected at a first filter output terminal to a positive input connection of an inverter, preferably on the DC side, to be connected at a second filter output terminal to a negative input terminal of an inverter, preferably on the DC side, and to be connected to a winding terminal of an electric machine connected to the inverter at a third filter output terminal. The filter circuit is characterized in that it comprises an x-capacitor, a first and a second y-capacitor. The x-capacitor is connected between the first and third filter output terminals, or the first and third filter input terminals. The first y-capacitor is connected between the third filter output terminal or the third filter input terminal and a reference potential or ground. The second y-capacitor is connected between the second filter output terminal or the second filter input terminal and a reference potential or ground.

Due to the resulting filter circuit, which is formed asymmetrically with respect to common mode suppression by means of the y-capacitors, since only one x-capacitor is connected to the first filter input terminal or the first filter output terminal, only the values of the first and second y-capacitors, which are respectively connected to the second or third filter input terminal or the first filter output terminal must be added together when taking into account the limit values for the permissible electromagnetic interference emissions. Advantageously, the first and the second y-capacitors can be dimensioned larger than if a third y-capacitor were to be taken into account for filtering the line between the first filter input and filter output terminals. Since the line between the first filter input and filter output terminal is not needed in booster mode, no y-capacitors are necessary at this point in the topology. The provided x-capacitor is sufficient for the relevant travel operation or charging operation.

According to the above numerical example, the y-capacitors could now be configured at 4×150 nF (instead of 100 nF each). The lines over which the charging voltage to be boosted flows are thus filtered particularly heavily. Preferably, any filter attenuation necessary after the y-capacitors limit value has been exhausted can only be adjusted by a common mode choke (CMC) between the y-capacitors. Advantageously, a smaller CMC can be used with such an asymmetric filter for operation with the charging voltage to be boosted that determines the configuration. This in turn provides advantages because less installation space is required, and because the associated weight is lower. In summary, an asymmetric filter is smaller, lighter, and less expensive. In order to nevertheless achieve a slightly reduced filtering effect also on the line between the first filter input terminal and the first filter output terminal, the x-capacitor is used to capacitively contact the y-capacitor on the line between the third filter input terminal and the first filter output terminal. This x-capacitor is provided instead of a third y-capacitor on the line between the first filter input terminal and the first filter out terminal. A corresponding third y-capacitor would be provided for a symmetrical filter. Advantageously, the sum of the capacities of the y-capacitors preferably remains the same. Preferably, the x-capacitor does not require a y-safety classification, and is therefore smaller, lighter, and cheaper.

Connecting and disconnecting or decoupling, or respectively, connected and disconnected are used as equivalent to galvanically connected and galvanically isolated.

In another configuration, the first and second y-capacitors have the same capacity. Thus, common mode interference on the line between the third filter output terminal and the third filter input terminal and the line between the second filter output terminal and the second filter input terminal are equally suppressed. Suppression of common mode interference on the line between the first filter output terminal and the first filter input terminal, preferably lacking a y-capacitor between the first filter output terminal and the first filter input terminal, is substantially weaker. Preferably, common mode interferences are suppressed on the line between the first filter output terminal and the first filter input terminal only via the x-capacitor in conjunction with the first y-capacitor, preferably by means of the capacitive coupling.

Advantageously, the dimensioning provided for the capacity values of the filter circuit ensures effective filtering for charging operation and for driving operation.

In another configuration, the x capacitor in conjunction with the first y-capacitor suppresses the common mode interferences on the line between the first filter output terminal and the first filter input terminal at least partially.

Advantageously, a circuit topology is provided that allows common mode suppression on the line between the first filter output terminal and the first filter input terminal instead of a third y-capacitor.

In one embodiment, the x-capacitor is provided instead of a third y-capacitor between the first filter output terminal or the first filter input terminal and a reference potential or ground.

Advantageously, a possibility for reducing the resulting sum of the capacity values of the y-capacitors is provided.

In one embodiment, the filter circuit is designed to be 1-stage, 2-stage, 3-stage, 5-stage or multi-stage. A first stage of a filter circuit, preferably a high voltage filter or a DC high voltage filter, comprises one associated capacitor per line, preferably to reduce common mode interference. With a two-stage filter, a longitudinal restriction, preferably a common mode choke (CMC), is additionally provided per line, preferably to reduce common mode interference. With a three-stage filter, another first stage of the filter circuit of the two-stage filter is added. With a four-stage filter, another second stage of the filter circuit of the three-stage filter is added. The same applies to filters of even higher orders. Preferably, the filter circuit is configured respectively as a 1st order filter circuit (1-stage), 2nd order filter circuit (2-stage), 3rd order filter circuit (3-stage) or nth order (multi-stage) filter circuit having nG N (n is an element of the natural numbers).

Advantageously, a possibility for forming multi-stage filter circuits is provided.

In one embodiment, the voltage at the positive pole of the high-voltage battery is greater at least by a factor of 1.2 than the voltage at the positive pole of the charging voltage.

Advantageously, a filter circuit is provided for filtering common mode interference that occurs in a charging operation in which an inverter operates as a booster in combination with the windings of an electric machine.

In one embodiment, the electric drive is preferably configured to operate a vehicle. The electric drive comprises an inverter and a multi-phase electric machine. The inverter comprises a positive input terminal on the input side and a negative input terminal for connecting the first filter output terminal and the second filter output terminal. On the output side, the inverter comprises a multi-phase connection, preferably an alternating voltage connection, for connecting the multi-phase electric machine. The inverter is configured to supply electrical power to the electric machine in motor operation and to receive electrical power of the electric machine in generator operation, wherein at least one of the windings of the multi-phase electric machine comprises a winding terminal that is connectable to a positive pole of a charging voltage.

Connectable means that the winding terminal is electrically connected to the positive pole of a charging voltage by means of the switch in a charging mode and is disconnected by means of the switch in the driving mode. The windings of the multi-phase electric machine are preferably connected in a star circuit; a delta circuit is also possible. The winding terminal is a contacting of at least one winding. Preferably, the star point is configured as a winding connection.

Advantageously, an electrical filter circuit for an electric drive is provided in which, the first and second y-capacitors may be dimensioned larger for effective filtering and consideration of a specified limit value for the sum of the capacities of the y-capacitors, than if a third y-capacitor for filtering the line between the first filter input and filter output terminals were to be taken into consideration.

Further, the invention relates to a drive train having the described electrical filter circuit. The drive train comprises the electrical filter circuit and the inverter, the multi-phase electric machine, and the high voltage battery. Advantageously, a drive train with an electrical filter circuit is provided, in which the first and second y-capacitors can be dimensioned larger than if a third y-capacitor was also to be taken into consideration for filtering the line between the first filter input and filter output terminals.

The invention also relates to a vehicle with the drive train. Advantageously, a vehicle is provided with an electrical filter circuit that allows for safe operation of the vehicle.

### BRIEF DESCRIPTION OF THE DRAWINGS

Shown are:

FIG. 1 a first schematic block diagram of an electric drive having an electrical filter circuit;

FIG. 2 a schematic illustration of a vehicle having an electric drive train with an electrical filter circuit;

In the figures, identical elements or elements with the same function are provided with the same reference signs.

### DETAILED DESCRIPTION

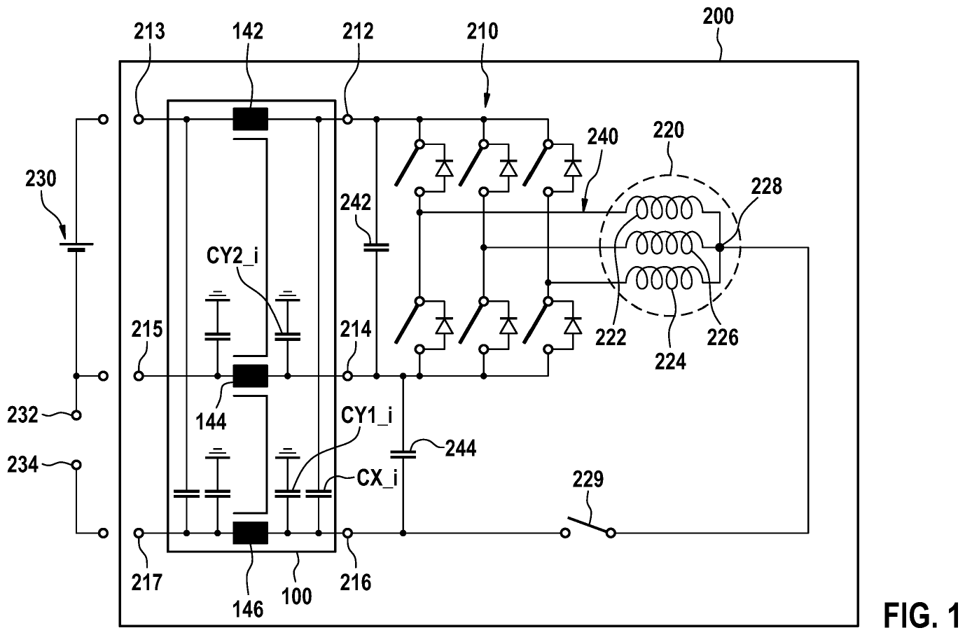

FIG. 1 shows a schematic block diagram of an electrical filter circuit 100 for an electric drive 200. The electric drive 200 is preferably configured to operate a vehicle 400. The electric drive 200 comprises an inverter 210 and a multi-phase electric machine 220. The inverter 210 comprises a positive input terminal on the input side and a negative input terminal for connecting an electrical filter circuit 100. Preferably, the inverter 210 comprises an input-side capacitor 242, preferably a DC link capacitor. On the output side, the inverter 210 comprises a multi-phase connector 240 for connecting the multi-phase electric machine 220, preferably for connection to the phase terminals of the individual phases, or windings, of the electric machine 220. The inverter 210 is configured to provide electrical power to the electric machine 220 in motor operation and to receive electrical power of the electric machine 220 in generator operation. Preferably, the power switching elements of the inverter 210 shown are controlled accordingly for this purpose. Preferably, by means of the power switching elements, preferably three half bridges connected in parallel are formed, which are connected to a DC voltage at the ends. Preferably, a center tap of each half bridge is connected to a phase connector for connecting one of the windings of the electric machine 220. The coils 222, 224, 226 of the multi-phase electric machine 220 are connected in a star circuit by way of example. A delta connection of the windings is also possible. One winding terminal 228, preferably a contacting on a winding of the electric machine 220 is preferably connected to a switching element 229. Preferably, the winding terminal is a phase terminal of the electric machine. However, contacting at another location of the winding is also possible as a winding terminal, preferably within the winding or at the other end of the winding, between the plurality of windings of the electric machine 220, preferably at a neutral point of the electric machine 220. The electrical filter circuit 100 comprises an input-side three-pole filter input connection 213, 215, 217, and an output-side three-pole filter output connection 212, 214, 216. The input-side three-pole filter input connection is configured to be connected to a positive pole of a high voltage battery 230 at a first filter input terminal 213, to be connected to a second filter input terminal 215 at a negative pole of the high voltage battery 230 and to be connected to a negative pole of a charging voltage 232, and to be connected to a positive pole of a charging voltage 234 at a third filter input terminal 217. The output-side 3-pole filter output connection is configured to be connected to a positive input connection of the inverter 210 at a first filter output terminal 212, to be connected to a negative input connection of the inverter 210 at a second filter output terminal 214 and to be connected to the winding terminal 228 of an electric machine 220 connected to the inverter 210 at a third filter output terminal 216. Preferably, the third filter output terminal 216 is switchably connected to the winding terminal 228 via a switching element 229. The electrical filter circuit 100 comprises an x-capacitor CX_i, a first and a second y-capacitor CY1_i, CY2_i. The CX_i x-capacitor is connected between the first and third filter output terminals 212, 216 or the first and third filter input terminals 213, 217. The first y-capacitor CY1_i is connected between the third filter output terminal 216 or the third filter input terminal 217 and a reference potential or ground. The second y-capacitor CY2_i is connected between the second filter output terminal 214 or the second filter input terminal 215 and a reference potential or ground. Preferably, with a two-stage filter, one winding 142,144,146, choke, or longitudinal restriction is disposed between each of the first, second and third filter input terminals and the first, second and third filter output terminals, respectively and connects the respective filter input terminal and the filter output terminal. Preferably, also with a three-stage filter, a further x-capacitor CX_i, a further first and a further second y-capacitor CY1_i, CY2_i, the previous x-capacitor CX_i, the previous first and second y-capacitor CY1_i, CY2_i are connected in parallel, as shown in FIG. 1. Preferably, with filters with even more stages, the number of x and y capacitors connected in parallel is increased and a winding is added between each of the individual capacitors. Preferably, any filter attenuation necessary after the y-capacitors limit value has been exhausted can only be adjusted by the windings 142, 144, 146, chokes, longitudinal restrictors or a common mode choke (CMC) between the y-capacitors. Advantageously, such an asymmetric filter can employ a smaller common mode choke 142, 144, 146 for the design-determining operation with the charging voltage to be boosted. Preferably, a second capacitor 244 is disposed between the second and third filter output terminals 214, 216. Preferably, in charging operation, this second capacitor 244 filters the voltage ripple between the second and third filter output terminals 214, 216, due to the alternating opening and closing of the power switching elements. Preferably, the switching element 229 is connected to the motor connector 228 on the one hand and connectable to the positive pole of the charging voltage 234 on the other hand via the third filter output connector 216 and the third filter input connector 217. Preferably, the negative pole of the charging voltage 232 is connectable to the second filter input terminal 215. Preferably, the positive and negative pole of the charging voltage 234, 232 is configured to be connected to a charging power source for charging operation for charging the power source 230. Preferably, the electric circuit 100 is disposed with the inverter 210 and/or the electric machine 220 inside a common housing. Alternatively, the electric circuit 100 may be disposed in a separate housing and connected by means of lines to the respective terminals and connections to the electric machine 220, the inverter 210, the power source 230, and the positive and negative pole of the charging voltage 234, 232.

Preferably, in another embodiment, the input-side three-pole filter input terminal is configured to be connected to a negative pole of a high voltage battery 230 at a first filter input terminal 213, to be connected to a positive pole of the high voltage battery 230 and a positive pole of a charging voltage 232 at a second filter input terminal 215, and to be connected to a negative pole of a charging voltage 234 at a third filter input terminal 217. The output-side 3-pole filter output connection is configured to be connected to a negative input connection of the inverter 210 at a first filter output terminal 212, to be connected to a positive input connection of the inverter 210 at a second filter output terminal 214 and to be connected to the winding terminal 228 of an electric machine 220 connected to the inverter 210 at a third filter output terminal 216.

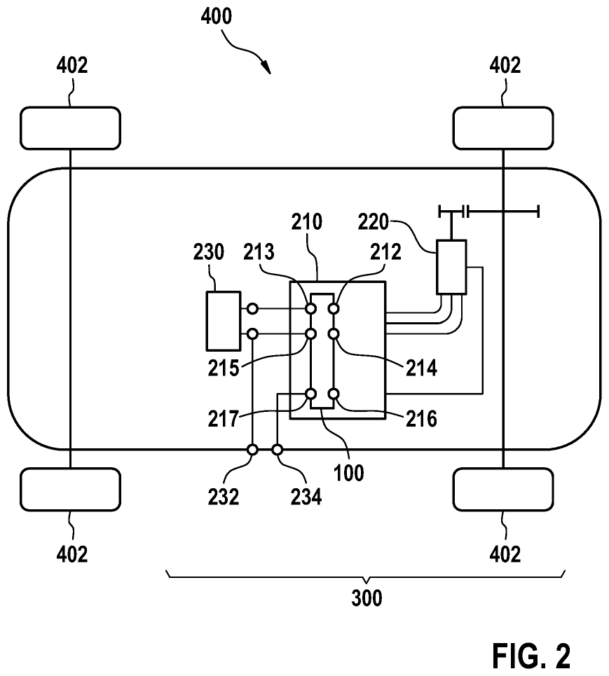

FIG. 2 shows a schematic illustration of a vehicle 400 having an electric drive train 300 and an electric circuit 100. Preferably, the vehicle 400 comprises four wheels 402, preferably at least one of which is driven by the electric machine 220. This illustration shows only one possible embodiment of a vehicle 400. Preferably, the vehicle is any vehicle for use in the water, on land, or in the air. The drive train 300 comprises the electrical filter circuit 100 and the inverter 210, the multi-phase electric machine 220, and/or the power source 230. Preferably, the electrical power source 230 is connected to the power switching elements of the inverter 210 via the electrical filter circuit 100. The charging terminals, i.e., the negative pole of the charging voltage 232 and the positive pole of the charging voltage 234, are configured to be connected to a charging power source (not shown) in charging operation for charging the power source 230.

1. An electrical filter circuit (100) for an electric drive (200), wherein the filter circuit comprises an input-side three-pole filter input connection (213, 215, 217) and an output-side three-pole filter output connection (212, 214, 216),
wherein the input-side three-pole filter input connection is configured to be connected to a positive pole of a high voltage battery (230) at a first filter input terminal (213), to be connected to a negative pole of a high voltage battery (230) and a negative pole of a charging voltage (232) at a second filter input terminal (215) and to be connected to a positive pole of a charging voltage (234) at a third filter input terminal (217), and
wherein the output-side three-pole filter output connector is adapted to be connected to a positive input connection of an inverter (210) at a first filter output terminal (212), connected to a negative input connection of an inverter (210) at a second filter output terminal (214) and connected to a winding terminal (228) of an electric machine (220) connected to the inverter (210) at a third filter output terminal (216), or
wherein the input-side three-pole filter input connection is configured to be connected to a negative pole of a high voltage battery (230) at a first filter input terminal (213), to be connected to a positive pole of the high voltage battery (230) and a positive pole of a charging voltage (232) at a second filter input terminal (215) and to be connected to a negative pole of a charging voltage (234) at a third filter input terminal (217), and
wherein the output-side three-pole filter output connection is configured to be connected to a negative input connection of the inverter (210) at a first filter output terminal (212), connected to a positive input connection of the inverter (210) at a second filter output terminal (214) and connected to the winding terminal (228) of an electrical machine (220) connected to the inverter (210) at a third filter output terminal (216)
wherein
the filter circuit (100) comprises an x-capacitor (CX_i), a first and a second y-capacitor (CY1_i, CY2_i),
wherein the x-capacitor (CX_i) is connected between the first and third filter output terminals (212, 216) or the first and third filter input terminals (213, 217), and the first y-capacitor (CYl_i) is connected between the third filter output terminal (216) or the third filter input terminal (217) and a reference potential or ground
and the second y-capacitor (CY2_i) is connected between the second filter output terminal (214) or the second filter input terminal (215) and a reference potential or ground.

2. The electrical filter circuit (100) of claim 1, wherein the first and second y-capacitors (CY1_i, CY2_i) have the same capacity value, whereby common mode interferences on the line between the third filter output terminal (216) and the third filter input terminal (217) and the line between the second filter output terminal (214) and the second filter input terminal (215) are suppressed uniformly, and are suppressed substantially less on the line between the first filter output terminal (212) and the first filter input terminal (213), and are suppressed only via the x-capacitor (CX_i) in conjunction with the first y-capacitor (CYI_i).

3. The electrical filter circuit (100) of claim 1, wherein the x-capacitor (CX_i) in conjunction with the first y-capacitor (CY1_i) at least partially suppresses the common mode interferences on the line between the first filter output terminal (212) and the first filter input terminal (213).

4. The electrical filter circuit (100) of claim 1, wherein the x-capacitor (CX_i) is provided between the first filter output terminal (212) or the first filter input terminal (213) and a reference potential or ground instead of a third y-capacitor (CY3_i).

5. The electrical filter circuit (100) of claim 1, wherein the filter circuit is designed to be 1-stage, 2-stage, 3-stage, 5-stage, or multi-stage.

6. The electrical filter circuit (100) of claim 1, wherein the voltage at the positive pole of the high voltage battery (230) is at least 1.2 times greater than the voltage at the positive pole of the charging voltage (234).

7. The electrical filter circuit (100) of claim 1, wherein the electric drive (200) comprises an inverter (210) and a multi-phase electric machine (220), wherein the inverter (210) comprises a positive input terminal and a negative input terminal for connecting the first filter output terminal (212) and the second filter output terminal (214) on the input side, and comprises a multi-phase terminal (215) for connecting the multi-phase electric machine (220) on the output side, wherein the inverter (210) is configured to supply the electric machine (220) with electrical power in a motor operation and receive electrical power of the electric machine (220) in a generator operation, wherein at least one of the windings of the multi-phase electric machine (220) comprises a winding terminal (228), connectable to a positive pole of a charging voltage (234).

8. A drive train (300) having an electrical filter circuit (100) of claim 1, wherein the drive train (300) comprises the electrical filter circuit (100) and the inverter (210), the multi-phase electric machine (220), and/or the power source (230).

9. A vehicle (400) having a drive train (300) according to claim 8.
